(19) United States
(12) Patent Application Publication
(10) Pub. No.: US 2010/0110260 A1
(43) Pub. Date: May 6, 2010

(54) DEVICE AND METHOD FOR RECORDING AND RECONSTRUCTING DIGITAL HOLOGRAM WITHOUT VIRTUAL IMAGE

(75) Inventors: Sang-Hoon Shin, Seoul (KR); Seung-Kil Choi, Daejeon (KR)

Correspondence Address: LRK Patent Law Firm, 1952 Gallows Rd, Suite 200, Vienna, VA, 22182, US

(73) Assignee: APNTECH CO., LTD., Daejeon (KR)

(21) Appl. No.: 12/532,490

(22) PCT Filed: Mar. 21, 2008
(86) PCT No.: PCT/KR08/01601

§ 371 Date: Sep. 22, 2009

(30) Foreign Application Priority Data
Mar. 22, 2007 (KR) 10-2007-0028325

(51) Int. Cl. H04N 5/335

(52) U.S. Cl. 348/311; 348/E05.091

(57) ABSTRACT

The present invention relates to a device and method for digital hologram recording and reconstructing that solves the problem of overlapping real and virtual images when reconstructing a hologram with a digital hologram device such as a digital hologram microscope. The device comprises a hologram reconstructing module for dividing the hologram area recorded on the CCD, recording in the interim each divided area whereby for each of the areas the pixel values of the rest of the areas except for that divided area is set to zero, outputting a reconstructed image with the virtual image removed by integrating each of the reconstructed hologram images recorded in the interim, and a control unit for controlling the hologram recording on the CCD, including dividing, mid-recording, and integration operations of the hologram reconstructing module, thus leading to perfect holographic information of the object.

### TECHNICAL FIELD

The present invention relates to a device and method for digital hologram recording and reconstructing, and in particular to a digital hologram recording and reconstructing device and method which can reconstruct holograms by completely removing the virtual image from the double image.

### BACKGROUND ART

Digital hologram technology originated from existing hologram technology (a method of recording and reconstructing 3 dimensional (3D) image by a process such as photography using a provided reference beam and hologram dry plate) is a method of acquiring hologram data of an object in real time using a moving picture recording apparatus such as CCD (Charge Coupled Device) and reconstructing the 3D image of the object by numerical calculation of 3D data.

The conceptual methodology was suggested about 30 years ago. The method of numerical calculation for 3D image reconstruction was developed in conjunction with the advancement of CCD technology and computational speed, and active research is carried out on wider and wider practical applications.

By recording the 3D data of the object through holography, we can acquire the 3D data of the object with one recording and represent the reorganized 3D data of the object (sample) through numerical reconstruction, and is thus incomparably superior to pre-existing high-tech microscopes.

Wide applications of such 3D data technology are expected in a variety of areas where 3D displays are desired.

The digital hologram microscopy is largely divided into those that use the object lens and those that do not, and those that use the object lens can be divided into the transmission type and the reflection type, while they are both digital hologram microscopy based on Mach-Zender type interferometry.

In using CCD instead of holographic film, information inputted to the CCD is the same as that exposed to holographic film and is also based on the same general principles of holography.

Generally for holographic recording, a laser beam is divided into two beams, where one is used as a reference beam and the other as an object beam, and the interference pattern from the two beams are recorded on a holographic dry plate. A 3D hologram of the object containing a real image and a virtual image is created by developing the recorded dry plate, and reconstructing the hologram by using a laser.

Upon numerical analysis, intensity of hologram I_{H}(x,y) on a particular point(x,y) on the hologram dry plate is expressed as follows:

I_{H}(x,y)=|R|²+|O|²+R*O+RO* [Math Figure 1]

Here, R is the reference beam, O is the object beam, R is a pair complex number of the reference beam, and O is a pair complex number of the object beam.

In Math Figure 1, the first term is intensity of the reference beam, the second term is the object beam intensity, the third term represents the virtual image, and the fourth term represents the real image.

Meanwhile, the angle overlapped between the reference beam and the object beam is limited by the limitation of the pixel size of the CCD when using the CCD device instead of holographic film, and only off-axis holograms and in-line holograms (Gabor hologram) which are limited in angle can be used to get holographic data.

Out of these holograms, the in-line hologram in particular has the advantage of getting the image by using the whole of the CCD.

However, in-line hologram has the problem of mixing the zero-order diffraction light, the real image, and the virtual image without distinction in reconstruction of the image.

Therefore, we can acquire the actual information of the object that is recorded by removing either the real image or the virtual image as well as the zero-order diffraction light in reconstructing the hologram.

Publicly known methods of removing zero-order diffraction light are DC-suppression, high-frequency filter method, and the method of removing zero-order diffraction light by recording only the object beam with the hologram.

However, these traditional methods of removing zero-order diffraction light only removes the zero-order diffraction light, the problem of double image overlap of the real image and virtual image remains.

### DISCLOSURE

### [Technical Problem]

It is an objective of the present invention to provide a method and device for recording and reconstructing digital hologram to get perfect information of the object by solving the problem of overlapping real image and virtual image in reconstructing a recorded hologram with a device for recording and reconstructing a digital hologram such as a digital hologram microscope.

### [Technical Solution]

To achieve the above-mentioned objective, the invention provides a device for recording and reconstructing a hologram on CCD, which divides a beam by the beam-splitter to make an object beam and a reference beam through the object and the 1st object lens, and the 2nd object lens, and make a hologram by interference of the object beam and the reference beam, which comprises a hologram reconstructing module for dividing the hologram area recorded on the CCD, making an interim recording of each divided area whereby the pixel values of the rest of the areas except for that divided area are set to zero, and reconstructing each hologram respectively in the interim recording, and outputting the reconstructed image without the virtual image by integrating each of the interim hologram images, and a control unit for controlling the hologram recording operation on the CCD, including dividing the hologram into areas, mid-recording and integration operations of the hologram by the hologram reconstructing module.

The hologram reconstructing module in the device for recording and reconstructing digital hologram of the present invention comprises a hologram dividing unit for dividing the hologram that is recorded on CCD into various areas, a hologram interim making an interim recording of each divided area whereby the pixel values of the rest of the areas except for that divided area are set to zero, and reconstructing each hologram respectively in the interim recording, and outputting the reconstructed image without the virtual image by integrating each of the interim hologram images, and a hologram integrating unit for outputting the reconstructed image without the virtual image by integrating the hologram images that are recorded in the interim.

Also, the control unit in the device for recording and reconstructing digital hologram of the present invention adjusts the position of the CCD in order to correspond the center position of the Fresnel zone which is the interference pattern generated by interaction of the object beam and the reference beam when the object is removed, with the center of the horizontal and vertical center lines of the recording face of the CCD before recording the hologram on the CCD.

To achieve the above-mentioned objective, the invention provides a method for recording and reconstructing a hologram on CCD, which divides a beam by the beam-splitter to make an object beam and a reference beam through the object and the 1st object lens, and the 2nd object lens, and make a hologram by interference of the object beam and the reference beam, which comprises the step of dividing the hologram area recorded on the CCD, the step of reconstructing and recording in the interim each divided area whereby for each of the areas the pixel values of the rest of the areas except for that divided area is set to zero, and the step of outputting the reconstructed image without the virtual image by integrating each of the reconstructed hologram images recorded in the interim.

The method for recording and reconstructing a digital hologram of the present invention first adjusts the position of the CCD in order to correspond the center position of the Fresnel zone which is the pattern generated by interaction of the object beam and the reference beam when the object is removed, with the center of the horizontal and vertical center lines of the recording face of the CCD, before recording the hologram on the CCD.

The method for recording and reconstructing a digital hologram of the present invention further comprises one or more of the step of removing the edge area displaying the virtual image of the overlapped hologram, and the step of removing the zero-order diffraction light in reconstructing the hologram through a method of removing the zero-order diffraction light.

In the embodiments of the present invention, the device and the method of the present invention symmetrically divides the hologram that is recorded on CCD into 4 areas in reference to the center point that is made by crossing the horizontal center line and the vertical center line of the CCD recording face.

### ADVANTAGEOUS EFFECTS

The present invention provides a device and a method for obtaining perfect object information by solving the problem of overlapping real and virtual image when recording and reconstructing holograms through a device such as a digital hologram microscope.

### DESCRIPTION OF DRAWINGS

FIG. 1 briefly illustrates a configuration that is especially suitable for a digital hologram microscope among devices for recording and reconstructing digital hologram according to an embodiment of the present invention.

FIG. 2 illustrates in detail an example of a hologram reconstructing module of FIG. 1 in the device for recording and reconstructing digital hologram according to an embodiment of the present invention.

(a) In FIG. 3 is a zone-plate type hologram picture that is displayed and recorded on CCD of an interference pattern that is made by interaction of the reference beam and the object beam when the object sample is removed, in a device for recording and reconstructing digital hologram of FIG. 1 according to the present invention, and (b) in FIG. 3 is a magnified picture of the center part of (a) in FIG. 3.

FIG. 4 is a picture showing an example of the hologram that is recorded with a CCD using a photomask pattern as the sample object in a device for recording and reconstructing digital hologram of FIG. 1.

FIG. 5 is a picture showing an example of a hologram created by CCD of FIG. 4 in the traditional method where the real and virtual images overlap.

FIG. 6 is a picture showing an example of a hologram created by CCD of FIG. 4 according to the present invention where the overlapping real and virtual images are spatially separated and reconstructed.

FIG. 7 illustrates the state before removing the virtual image at the peripheral areas and the zero-order diffraction light at the center, in the reconstruction of the hologram according to an embodiment of the present invention.

FIG. 8 is an operation flowchart that briefly shows the method for recording and reconstructing digital hologram according to an embodiment of the present invention.

### BEST MODE

The above-mentioned advantages and characteristics of the present invention, and the method of obtaining them, will become more apparent by reference to the following description of the invention taken in conjunction with the accompanying drawings. The present invention is not limited by the embodiments of the invention described below, but can be realized in various forms. The present invention is fully disclosed by the embodiments so that others skilled in the art can completely understand the spirit and scope of the present invention. The scope of the present invention is defined only by the claims. Corresponding reference symbols indicate corresponding parts throughout the disclosure.

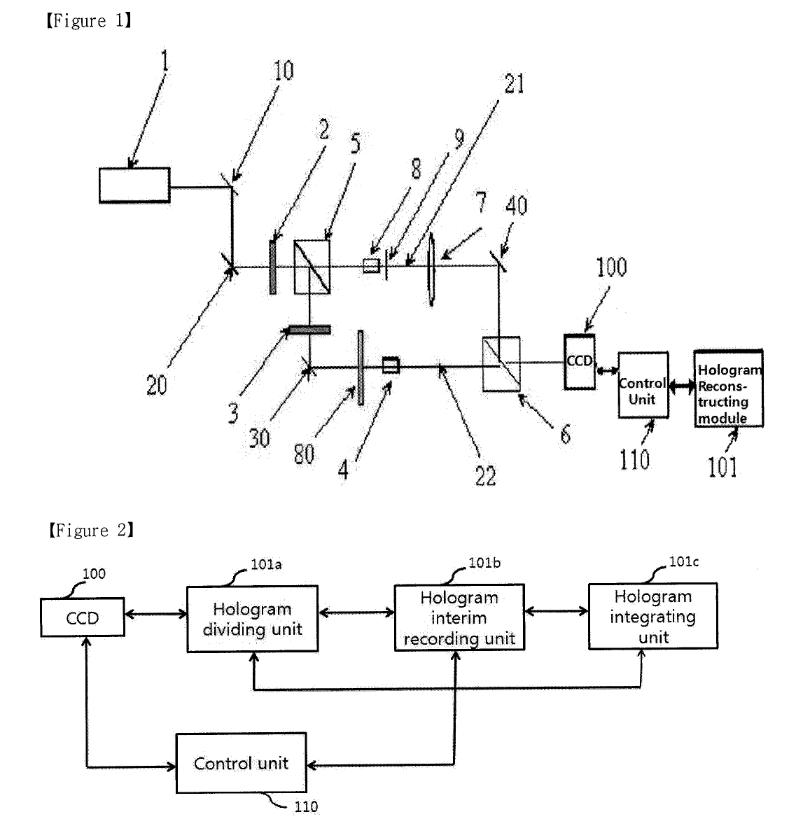

FIG. 1 briefly illustrates a configuration that is especially suitable for a digital hologram microscope among devices for recording and reconstructing digital hologram according to an embodiment of the present invention.

FIG. 1 illustrates a device for recording and reconstructing digital hologram using Mach-tender type interferometry in particular.

Device for recording and reconstructing digital hologram of the present invention largely comprises a light source (1), the part (10,20,2,5,8,9,7,40,6) that makes a reference beam, the part (10,20,2,5,3,30,80,4) that makes an object beam, CCD (100) that records the pattern made by interaction of the object beam and the reference beam, a hologram reconstructing module (101) that outputs a reconstructed image without a virtual image by dividing/recording in the interim/integrating the hologram recorded on CCD, a control unit (110) for controlling the operation of recording on the CCD, and dividing, recording in the interim, and integrating the hologram by the hologram reconstructing module, wherein the hologram reconstructing module (101) can comprise a recording medium that has software for numerically analyzing the interference fringes recorded on CCD.

A laser beam with good coherency is used as the light source (1). For example, cw He—Ne laser with a wavelength of 632.8 nm can be used. The laser beam is reflected through two mirrors (10, 20) onto the beam-splitter (5), and the intensity of the laser beam can be controlled by the first neutral filter (2).

To make a reference beam, the laser beam of the light source (1) is divided into 2 beams through the beam-splitter (5). The beam-splitter (5) can be a half-mirror for example.

Of the two beams divided by the beam-splitter (5), one beam is used as a reference beam (21). As one example of creating a reference beam, the beam can be magnified to a certain size using the 2nd object lens (8), pinhole (9), and lens (7) and the reference beam (21) can be generated by making parallel light rays of the TEM₀₀ shape.

The other beam divided by the beam splitter (5) passes through the neutral filter (3) which adjusts the intensity of the beam, and reflected with a reflector (30), and is incident onto a photo-mask object (80) to form an image of the object at a certain distance with the 1st object lens (4). The intensity of the object beam can be controlled by the 2nd neutral filter (3). For example, the 1st object lens (4) can have 10×, 20×, 50×, or 100×, etc magnifications.

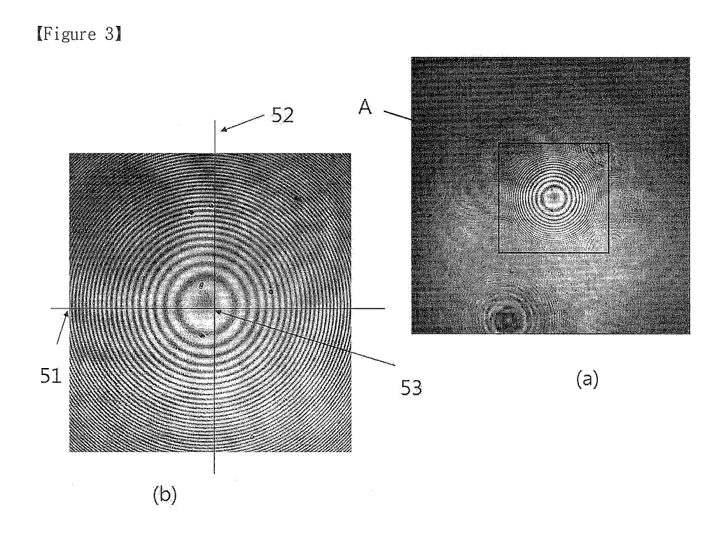

FIG. 2 illustrates in detail an example of a hologram reconstructing module (101) of FIG. 1 in the device for recording and reconstructing digital hologram according to an embodiment of the present invention, which comprises a hologram dividing unit (101a) for dividing the hologram that is recorded by the CCD into various areas, an interim hologram recording unit (101b) for recording in the interim each divided area whereby for each of the areas the pixel values of the rest of the areas except for that divided area is set to zero, and a hologram integrating unit (101c) for outputting the reconstructed hologram without virtual image by integrating each of the reconstructed hologram images recorded in the interim.

(a) in FIG. 3 is a zone-plate type hologram picture that is displayed and recorded on CCD (100) of an interference pattern that is made by interaction of the reference beam and the object beam when the object (80) sample is removed, in a device for recording and reconstructing digital hologram of FIG. 1 according to the present invention, and (b) in FIG. 3 is a magnified picture of the center part (A) of (a) in FIG. 3.

As shown in (a) and (b) of FIG. 3, a round Fresnel Zone type pattern is shown on the CCD.

In a preferable embodiment of the present invention, as shown in (b) of FIG. 3, the center of the circle of the Fresnel Zone is at the position where the horizontal center line (51) crosses the vertical center line (52) of the CCD (100) recording face (52), that is the middle point (53) of the two center lines (51, 52). For example, if the CCD (100) consists of 1024 pixels×1024 pixels, the pixel position of the center (53) is at 512 on the horizontal axis and pixel 512 on the vertical axis.

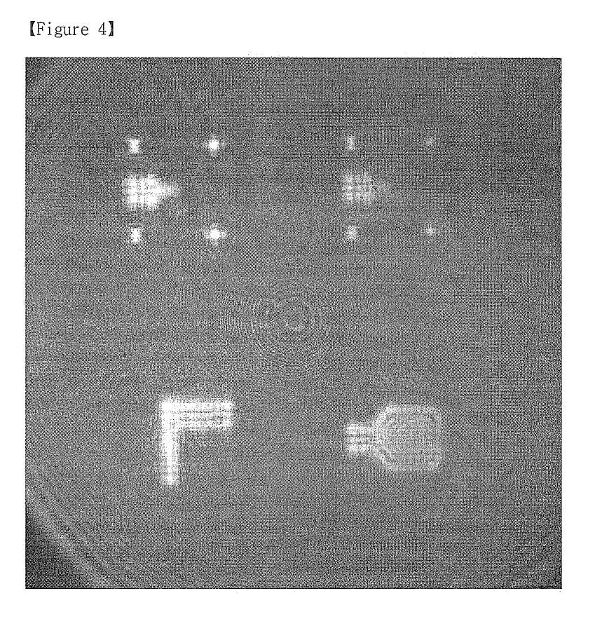

FIG. 4 is a picture showing an example of the hologram that is recorded with a CCD using a photomask pattern as the sample object (80) in a device for recording and reconstructing digital hologram of FIG. 1, where only the part of the laser beam that passes through the open part of the photo-mask pattern is projected onto the recording face of the CCD. As shown in FIG. 4, we can see the interference pattern from the interaction of the object beam that passed the object (80) and the reference beam.

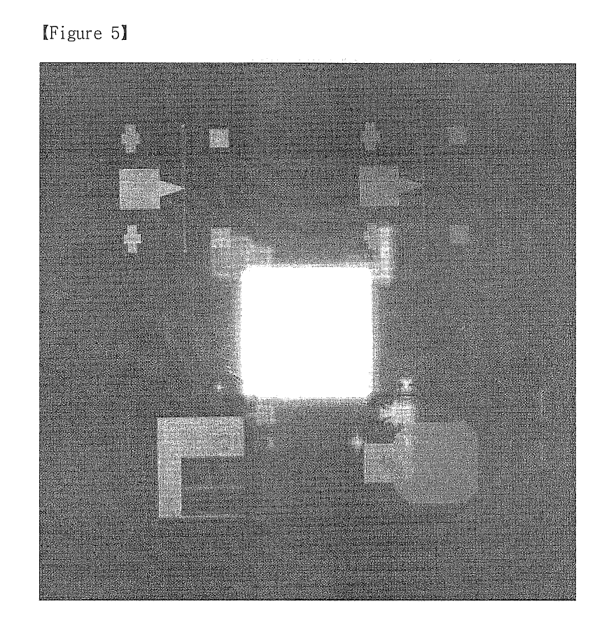

FIG. 5 is a picture showing an example of a hologram created by CCD of FIG. 4 in the traditional (common numerical analysis) method where the real and virtual images overlap.

As shown in FIG. 5, a bright square shape can be seen in the center of the picture, and rather clearly defined shapes (a rocket shape at upper left, a rocket shape at the upper right, a lattice shape at lower left, a water bottle shape at lower right) are shown around it. Also rather dimly defined shapes (a water bottle shape at upper left, a lattice shape at upper right, a rocket shape at lower left, a rocket shape at lower right) can be seen around the clearly defined shapes. The bright square area in the center of the picture is the zero-order diffraction light, the clearly defined shapes make up the real image, while the dimly defined shapes make up the virtual image. A zero-order diffraction light beam can be removed by traditional techniques such as DC-suppression method or by using high-frequency pass filters.

Analysis of FIG. 5 shows that the virtual image at the periphery is turned around by 180 degrees relative to the real image around it. Furthermore, the virtual image at the periphery is reduced in size compared to the real image.

Therefore, the device and the method for recording and reconstructing a digital hologram according to the embodiment of the present invention divides the hologram recorded on the CCD (100) recording face into four areas in order to separate the real image from the virtual image. The four areas are divided by the horizontal center line (51) and the vertical center line (52). The four areas shall be referred to as areas A, B, C, and D respectively.

For the four areas to be divided in exact symmetry, it is preferable that the center of the concentric circle of the Fresnel zone recorded without the object correspond to the center of the CCD. The control unit (110) can control the position of the CCD (100) in order to divide the four areas in exact symmetry.

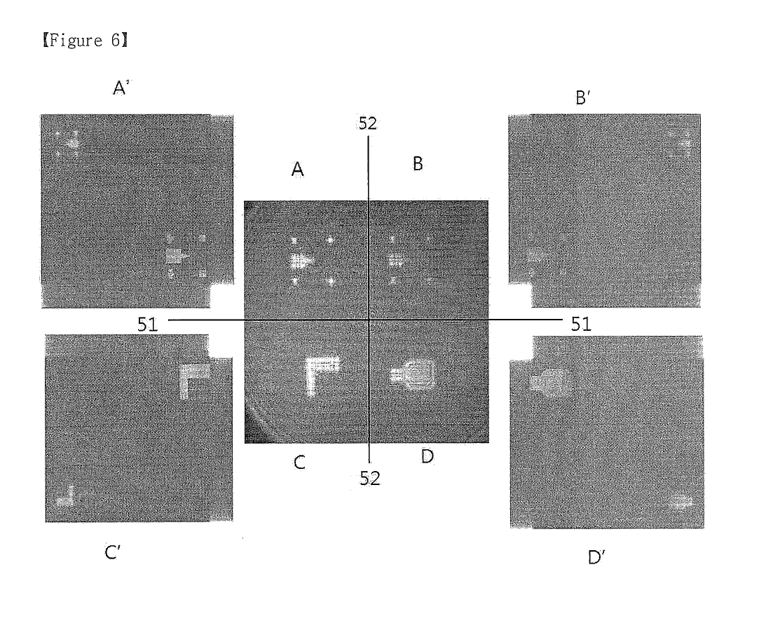

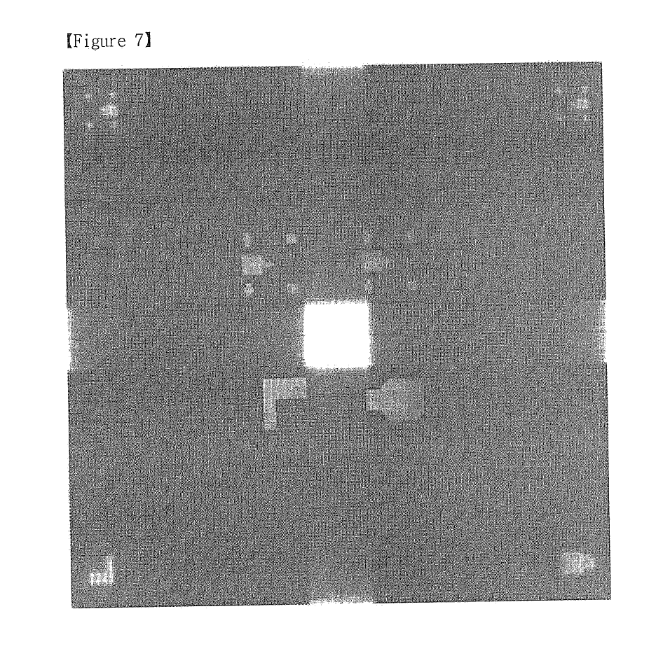

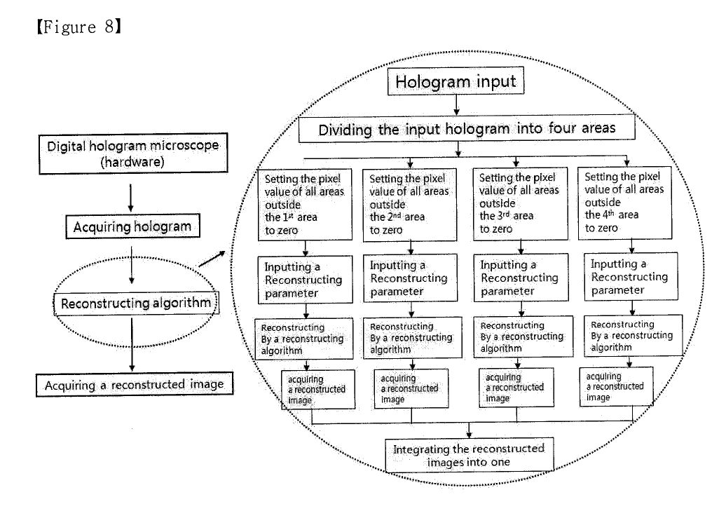

FIG. 6 is a picture showing an example of a hologram created by CCD of FIG. 4 according to the present invention where the overlapping real and virtual images are spatially separated and reconstructed, while FIG. 7 illustrates the state before removing the virtual image at the peripheral areas and the zero-order diffraction light at the center, in the reconstruction of the hologram, and FIG. 8 is an operation flowchart that briefly shows the method for recording and reconstructing digital hologram according to an embodiment of the present invention.

The control unit (110) records the hologram data through the CCD (100), and controls the operation of dividing/recording in the interim/integrating the hologram by the hologram reconstructing module (101).

Hereby, the hologram reconstructing module (101) as shown in FIG. 8 divides the hologram that is recorded by the CCD into four areas with the hologram dividing unit (101a), records in the interim each divided area whereby for each of the areas the pixel values of the rest of the areas except for that divided area is set to zero with the interim hologram recording unit (101b), and outputs the reconstructed hologram without virtual image by integrating each of the reconstructed hologram images recorded in the interim with the hologram integrating unit (101c).

This process can be created with software saved on the recording medium, and the recording medium can be ROM, RAM, or other kind of memory, or a storage device such as magnetic disks and optical disks.

A detailed description of the operation of dividing/recording in the interim/integrating by the hologram reconstructing module (101) is as follows.

First of all, the hologram on the recording face of the CCD (100) divides the hologram into areas A, B, C, and D and records in the interim a temporary reconstruction of each area. That is, for area A a temporary reconstruction of that area whereby the pixel values of the rest of the areas outside area A is set to zero and recording in the interim. The same is done for other areas, so that a temporary reconstruction of area B is created whereby the pixel values of the rest of the areas outside area B is set to zero and recording in the interim, a temporary reconstruction of area C is created whereby the pixel values of the rest of the areas outside area C is set to zero and recording in the interim, and a temporary reconstruction of area D is created whereby the pixel values of the rest of the areas outside area D is set to zero and recording in the interim. The temporarily reconstructed images are shown in A′, B′, C′, and D′.

As shown in A′, B′, C′, and D′ of FIG. 6, the virtual image is reduced in size and turned around by 180 degrees compared to the real image as in the case of general hologram reconstruction methods by numerical analysis. Also, the virtual image on the peripheral area is reduced in the size compared to the real image. Because the virtual image is reduced in size and on the peripheral area, we can create and output a picture such as A, B, C, and D if we synthesize A′, B′, C′, and D′ and remove the peripheral part.

In FIG. 6 the picture in the center is a picture (planar picture) reconstructed through the numerical analysis method of hologram reconstruction according to device and method for recording and reconstructing a digital hologram of the present invention, where the virtual image on the peripheral area and the zero-order diffraction light at the center part was removed. It can be seen that when the virtual image on the peripheral area and the zero-order diffraction light at the center part is removed as in the center picture of FIG. 6, it is almost the same as the picture in FIG. 4.

FIG. 7 shows the state before removing the virtual image on the peripheral area and the zero-order diffraction light at the center part. We can remove the zero-order diffraction light at the center part by using publicly known technology such as DC-Suppression method or passing through a high-frequency pass filter, while the picture in the peripheral area can be removed by simple deleting the picture physically.

FIG. 8 is an operation flowchart that shows the numerical analysis process in an embodiment of the present invention. The numerical analysis method used in the hologram reconstructing algorithm in FIG. 8 is as follows.

The only difference between digital holography and digital hologram microscopy is the magnification of the object beam by lens (M0). The CCD is generally used as the device for storing the hologram in digital holography. The specifications of the CCD are the pixel number (Nx×Ny), pixel size (Δx×Δy), and sensor size (Lx×Ly). The interference intensity information that is stored in pixel (k, 1) of the CCD is as Math Figure 2.

$${I}_{h} ( k , l ) = {I}_{h} ( x , y ) rect ( \frac{x}{{L}_{x}} , \frac{y}{{L}_{y}} ) {\sum }_{k = - {N}_{x} / 2}^{{N}_{x} / 2} {\sum }_{l = - {N}_{y} / 2}^{{N}_{y} / 2} δ ( x - k Δ x , y - l Δ y ) \qquad [ Math Figure 2 ]$$

As in Math Figure 2, the hologram data from the reference and object beams are used in reconstructing a numerical image. A numerically reconstructed wave using the reference beam and the hologram data (1h) is expressed by Math Figure 3.

Ψ=RIₕ=R|R|²+R|O|²+RR*O+RRO* [Math Figure 3]

Here, the 1st term and the 2nd term are zero-order diffractions, the 3rd term is the virtual image, and the 4th term is the real image. The wave distribution at the point where the image is formed according to Fresnel's equation is shown in Math Figure 4.

$$Ψ ( ξ , η ) = A exp [ \frac{i η}{λ d} ( {ξ}^{2} + {η}^{2} ) ] \times \int \int {I}_{h} ( x , y ) exp [ \frac{i π}{λ d} ( {x}^{2} + {y}^{2} ) ] exp [ \frac{i 2 π}{λ d} ( x ξ + y η ) ] d x d y \qquad [ Math Figure 4 ]$$

Here, λ is the wavelength of the light used, d is the distance between the CCD to the point that the image is reconstructed, and A is a constant.

The Math Figure 4 is a Fourier Transform of

$${I}_{h} ( x , y ) exp [ \frac{i π}{λ d} ( {x}^{2} + {y}^{2} ) ]$$

into the frequency domain (ξ/λd, η/λd). In general, a FFT (Fast Fourier Transform) algorithm is used to calculate Math Figure 4. Because Math Figure 4 is a complex number, the reconstructed image is obtained as Math Figure 5.

I(m,n)=Re[Ψ(m,n)]²+Im[Ψ(m,n)]² [Math Figure 5]

And the phase image is given as Math Figure 6.

$$φ ( m , n ) = arc tan \frac{Im [ Ψ ( m , n ) ]}{Re [ Ψ ( m , n ) ]} \qquad [ Math Figure 6 ]$$

A 2-dimensional image and a 3-dimensional image can be created by using Math Figure 5 and Math Figure 6.

The four divided holograms are each reconstructed using Math Figure 2 to Math Figure 6, and parameters must be input for the reconstruction. The main input parameters are the CCD specifications, the wavelength of the light, and the d value (distance from the CCD to the point that the image is reconstructed). In reconstructing a hologram of the 1st, 2nd, 3rd, and 4th areas, we input the same value of the parameters. A reconstructed image is obtained by inputting the input parameter as an input value of the reconstructing algorithm when reconstructing. The reconstructed images are of the 1st area, the 2nd area, the 3rd area, and the 4th area. A reconstructed image can be obtained by integrating all of the above reconstructed images of the 1st area, the 2nd area, the 3rd area, and the 4th area into one.

### INDUSTRIAL APPLICABILITY

Since the present invention can provide perfect information of the sample by doing away with the problem of overlapping virtual and real images in reconstructing holograms with devices for recording and reconstructing digital holograms such as digital hologram microscopes, a wider variety of sample data display needs can be met, and applications in various fields will be possible where holography is used.

1. The device for recording and reconstructing a hologram on a CCD, which divides a beam with a beam-splitter, make an object beam and a reference beam through the object and the 1st object lens, and the 2nd object lens respectively, to make a hologram by the interference of the object beam and the reference beam; the device for recording and reconstructing digital hologram comprising:
a hologram reconstructing module for dividing the hologram area that is recorded on the CCD, recording in the interim a reconstructed hologram of each divided area whereby the pixel values of the rest of the areas outside each area is set to zero and integrating the reconstructed holograms recorded in the interim to output a reconstructed image with the virtual image removed; and
a control unit for controlling the hologram recording operation onto the CCD and the hologram dividing, interim recording and integrating operation by the hologram reconstructing module.

2. The device of claim 1, wherein the hologram reconstructing module symmetrically divides the hologram that is recorded on the CCD in reference to the center point that is made by crossing a horizontal center line and a vertical center line of the CCD recording face.

3. The device of claim 1, wherein the hologram reconstructing module symmetrically divides the hologram that is recorded on the CCD into four areas in reference to the center point that is made by crossing a horizontal center line and a vertical center line of the CCD recording face.

4. The device of claim 1, wherein the hologram reconstructing module comprises:
a hologram dividing unit for dividing the hologram that is recorded on the CCD into various areas;
a hologram interim recording unit for recording in the interim a reconstructed hologram whereby the pixel values of the rest area outside each area divided by the hologram dividing unit is set to zero; and
a hologram integrating unit for outputting the reconstructed image with the virtual image removed by integrating all of the hologram images that are recorded in the interim.

5. The device of claim 1, wherein the control unit adjusts a position of the CCD in order to correspond the center position of the Fresnel zone which is the pattern generated by the interaction of the object beam and the reference beam in the absence of the object, with the central point that is made by crossing a horizontal center line and a vertical center line of the recording face of the CCD before recording the hologram on the CCD.

6. The method for recording and reconstructing a digital hologram on CCD, which divides a beam with a beam-splitter, make an object beam and a reference beam through the object and the 1st object lens, and the 2nd object lens respectively, to make a hologram by the interference of the object beam and the reference beam; the method for recording and reconstructing digital hologram comprising the steps of:
dividing the hologram recorded on CCD into various areas;
recording in the interim a reconstructed hologram of each divided area whereby the pixel values of the rest of the areas outside each area is set to zero; and
outputting a reconstructed image with the virtual image removed by integrating each of the reconstructed hologram images recorded in the interim

7. The method of claim 6, wherein the hologram is divided symmetrically in reference to the center point that is made by crossing a horizontal center line and a vertical center line of the CCD recording face.

8. The method of claim 7, wherein the hologram is equally divided into four areas in reference to the center point that is made by crossing a horizontal center line and a vertical center line of the CCD recording face.

9. The method for claim 6, wherein the method further comprises the step of first adjusting a position of the CCD in order to correspond the center position of the Fresnel zone which is the interference pattern generated by the interaction of the object beam and the reference beam in the absence of the object, with the central point that is made by crossing a horizontal center line and a vertical center line of the recording face of the CCD before recording the hologram on the CCD.

10. The method of claim 6, wherein the method further comprises the step of removing the peripheral area displaying a virtual image in the hologram integrated by the step of integrating the hologram.

11. The method of claim 6, wherein the method further comprises the step of removing a zero-order diffraction light during reconstruction of the hologram by a method of removing zero-order diffraction light.

12. The method for recording and reconstructing a digital hologram on a CCD, which divides a beam with a beam-splitter, make an object beam and a reference beam through the object and the 1st object lens, and the 2nd object lens respectively, to make a hologram by the interference of the object beam and the reference beam; the method for recording and reconstructing digital hologram comprising the steps of:
first adjusting a position of the CCD in order to correspond the center position of the Fresnel zone which is the interference pattern generated by the interaction of the object beam and the reference beam in the absence of the object, with the central point that is made by crossing a horizontal center line and a vertical center line of the recording face of the CCD before recording the hologram;
dividing the hologram recorded on CCD into various areas;
recording in the interim a reconstructed hologram of each divided area whereby the pixel values of the rest of the areas outside each area is set to zero;
outputting a reconstructed image by integrating each of the reconstructed hologram images recorded in the interim;
removing the peripheral area displaying a virtual image in the hologram integrated by the step of integrating the hologram; and
removing a zero-order diffraction light during reconstruction of the hologram by a method of removing zero-order diffraction light.

13. The method of claim 12, wherein the hologram is symmetrically divided into four areas in reference to the center point that is made by crossing a horizontal center line and a vertical center line of the CCD recording face.
